(19) United States
(12) Patent Application Publication
(10) Pub. No.: US 2015/0101544 A1
(43) Pub. Date: Apr. 16, 2015

(54) Brush to Simulate Natural Grooming

(71) Applicant: Keith Ablow, Newburyport, MA (US)

(72) Inventor: Keith Ablow, Newburyport, MA (US)

(21) Appl. No.: 14/050,745

(22) Filed: Oct. 10, 2013

(51) Int. Cl. A01K 13/00

(52) U.S. Cl. CPC A01K 13/002
USPC 119/600

(57) ABSTRACT

A brush adapted for pet grooming consisting of one or more simulated cat tongues mounted on a hand graspable assembly and may further include a sound/vibration producing module for replicating the presence of a live animal during the grooming process.

### BACKGROUND OF THE INVENTION

1. Field of the Invention

This application relates generally to pet grooming products, and more specifically to a brush that includes one or more simulated cat tongues to help replicate a natural grooming process.

2. Description of the Prior Art

Various man-made and designed grooming brushes exist in the market. In general, these brushes can include a rigid brush head with multiple tines extending outward. The tines can be attached to the brush head, or the head and tines can be formed as a single assembly. The tines can vary in shape and are designed to travel through an animal's coat in an effort to remove excess hair and other debris. A potential drawback of such designs is that the tines can be too long or too ridged and thus can scratch the skin of the animal. It is also likely that using a brush of such a design creates an unnatural experience for the animal and may increase their discomfort during the grooming process. This can be particularly true for some domestic pets which have a reputation for being capricious in matters of human attention (i.e., cats). Many cats do not enjoy the grooming process for reasons only they are aware of It may be that this dislike stems from the exemplary drawbacks described above. A particular cat, however, may have no reason for disliking the grooming process. The reasons are exemplary only, and not a limitation, as cat behavior is difficult to determine. Nonetheless, there is motivation to provide a more natural experience for a cat during the grooming process. A natural grooming experience may provide comfort to a cat, and can improve their health and hygiene by removing dirt and excess hair (e.g., reducing hairballs).

### SUMMARY OF THE INVENTION

In accordance with aspects of the invention, one or more of the following capabilities may be provided. One or more simulated cat tongues can be affixed to a brush assembly. The brush assembly can include a fixed head or a removable head. The simulated cat tongues can include multiple rasps which replicate the papillae surface of an actual cats tongue. Debris and excess hair can be removed. The simulated cat tongue can be wetted to enhance the grooming. A vibrating option can be disposed in the brush assembly. A purring sound option can be disposed in the brush assembly. A more natural grooming process can be simulated.

These and other capabilities of the invention, along with the invention itself, will be more fully understood after a review of the following figures, detailed description, and claims.

### DESCRIPTION OF THE DRAWINGS

FIG. 1 is an exemplary brush assembly with multiple horizontally mounted simulated cat tongues.

FIG. 2 is an expanding diagram of an exemplary simulated cat tongue and rasps.

FIG. 3 is an exemplary brush shaft and removable head assembly.

FIG. 4 includes multiple views of an exemplary double paddle brush assembly with multiple cat tongues.

FIG. 5 includes exemplary configurations for different round and paddle type brush assemblies.

FIG. 6 includes exemplary embodiments of brush assemblies.

FIG. 7 is an exemplary process for grooming a pet with a simulated cat tongue.

### DESCRIPTION OF THE PREFERRED EMBODIMENTS

Embodiments of the invention provide techniques for simulating natural grooming with a brush assembly. This brush assembly is exemplary, however, and not limiting of the invention as other implementations in accordance with the disclosure are possible.

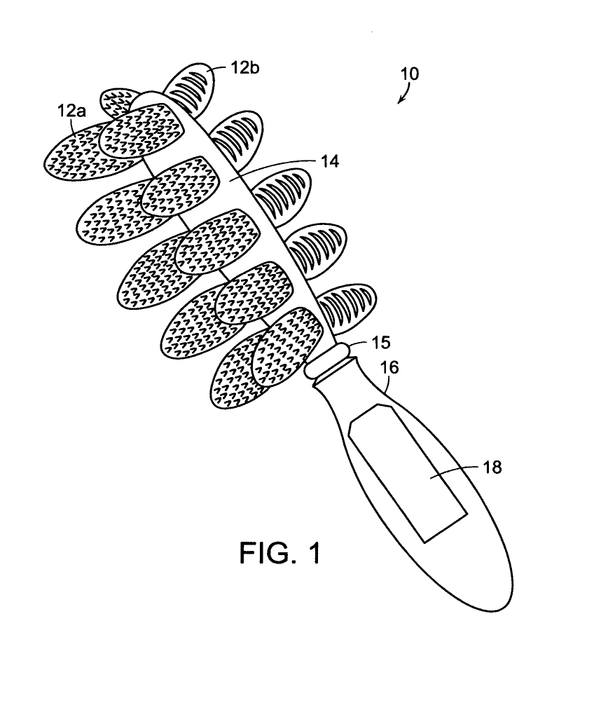

Referring to FIG. 1, an exemplary brush assembly 10 with multiple horizontally mounted cat tongues 12a is shown. The brush assembly 10 includes a plurality of simulated cat tongues 12 affixed to a casing 14, and a handle portion 16. The handle portion 16 can include an optional vibration module 18. In an embodiment, the vibration module 18 can be activated while grooming a pet to simulate purring and/or provide soothing vibrations to the pet. In an embodiment, the brush assembly 10 can include a speaker and sound producing circuit configured to produce a purring sound, or other sounds that can comfort the pet (e.g., fish tank bubbles, wind chimes, ocean waves, crackling fire). The brush assembly 10 includes a shaft portion (not shown in FIG. 1) and the casing 14 is configured to be removable from the shaft. For example, the casing 14 can be made of rubber or other pliant material (e.g., silicone, plastic, leather) and can slide over the shaft. The simulated cat tongues 12 can be affixed to the casing 14 (e.g., glued, fused, stitched, welded, pressure fitted), or the casing 14 and tongues 12 can be fabricated in one or more molds (e.g., sections of the casing 14 can be an integral assembly with one or more tongues 12). The casing 14 can include a raised section 15 at one end to facilitate the installation of the casing 14 over the shaft (e.g., the raised section 15 provides an area for a user to grip). In this way, the casing 14 and the affixed simulated cat tongues 12 can be removed from the handle portion for cleaning, disposal, or other reasons. The removable casing 14 is exemplary only, and not a limitation, as the brush assembly can include a non-removable casing affixed to, or otherwise integral with, the handle portion 16.

In an embodiment, the simulated cat tongues 12 can include a front side 12a and a backside 12b. The front side 12a is comprised of a collection of small rasps (e.g., tines) that simulate the papillae of the cat tongue. In an example, the tines are directionally biased towards the casing 14 and thus create a rasping effect (e.g., a rougher texture when the front side 12a is moved in one direction). The backside 12b can include a smoother surface (i.e., without rasps) and can be configured to allow the tongue 12 to curl backwards. That is, the simulated tongue 12 is comprised of a pliant material which will bend when the front face 12a is put into contact with another object (i.e., as when a cat licks an object). In an embodiment, the backside 12b can include a porous material configured to retain liquids if the simulated cat tongue 12 is wetted. For example, the brush assembly 10 can be used with water (or other liquids) while grooming a pet.

The brush assembly 10 can include several simulated cat tongues 12 which extend around the brush 10 in longitudinal rows. The brush 10 can have 2, 3, 4 or more rows of tongues 12, with each row including 4, 5, or 6 tongues 12. The number of rows and the number of tongues in a row are exemplary only and not a limitation as the brush 10 can include different configurations for the cat tongues 12.

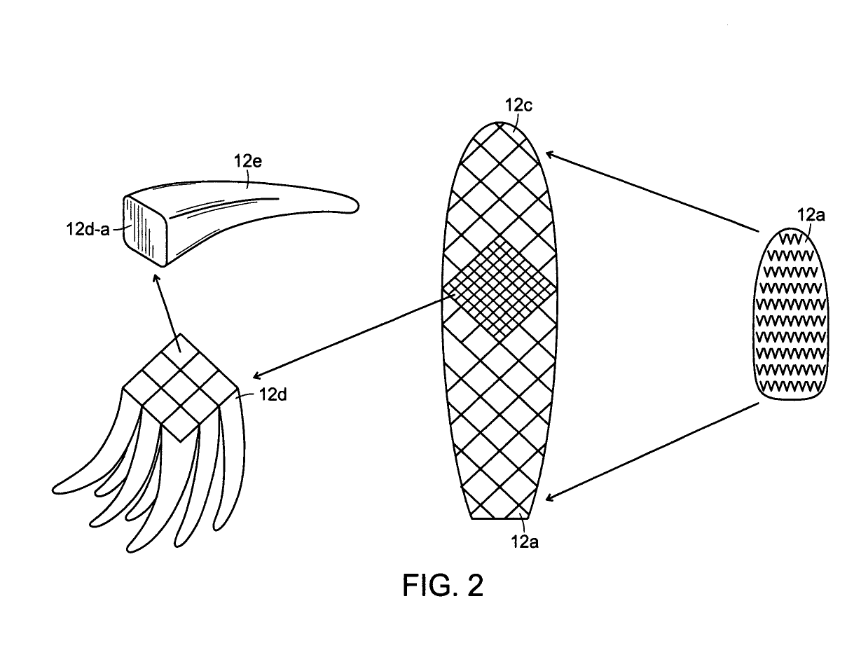

Referring to FIG. 2, with further reference to FIG. 1, an expanding diagram of the front side of an exemplary simulated cat tongue 12 is shown. The front side 12a includes a plurality of rasps 12e. In an embodiment, the rasps 12e can be assembled in small sections 12c and affixed to the front face 12a. For example, as depicted in FIG. 2, each section 12c can include 9 rasps 12e in a 3×3 matrix 12d, with each rasp 12e occupying an area 12d-a. This configuration is exemplary only and not a limitation as other rasp type assemblies may be used.

In an embodiment, the simulated cat tongue 12 can be a polymer melt which is injection molded to form the semi-rigid rasps 12e. The injection molding process can be either a batch method using conventional injection molding or a continuous injection molding process. The batch method can produce individual sheets of rasps and the continuous process can produce rolls. The simulated cat tongue 12 can be comprised of, for example, thermoplastic polymers such as nylon (polyamide 66 or PA-66), polycarbonate (PC), polyester (polyethylene terephlalate or PET), polystyrene (PS), rigid polyvinylchloride (PVC), acrylonitrile butadiene styrene (ABS), and polypropylene (PP). Polymer blends can also be used.

An exemplary front side 12a of a simulated cat tongue can include an areal density of the rasps in a range of 80 to 235 rasps (e.g., tines) per square centimeter. As an example, and not a limitation, the dimensions of each rasp can be 0.5±0.1 mm in diameter at the base 12d-a with a tapered profile, a length in the range of 500-800 μm, and a desired stiffness in the range of 2.5±1.5 GPa. Other dimensions may also be used. The rasps 12e can be inclined in the same direction at a 30°-60° angle between the underside of the rasp 12e and the top surface of the sheet or roll. The angle may be formed either with the shape of the mold or by a heat-setting process after the rasps 12e are formed. The sheets or rolls of rasps 12e can be cut or stamped into the tongue shaped pieces. In an embodiment, the tongue shaped rasp pieces can be glued, fused, or otherwise attached a side material to create the tongue shape tiles 12a. In general, the material used in the tiles 12a is more flexible than the rasps 12e. In an embodiment, the sheets or rolls of rasps can be glued or fused to a more flexible backing and then be stamped or cut into tongue shaped pieces 12a. Alternatively, in an embodiment, the rasp piece and the backing can be sequentially molded to form a composite piece. First the rasp mold would be used and then the sheet would be transferred to a second mold which would inject the backing material to form a more flexible sheet fused with the rasp sheet during processing. In an embodiment, the rasps and some or all of the casing 14 can be molded as a single assembly. Other manufacturing process may be used.

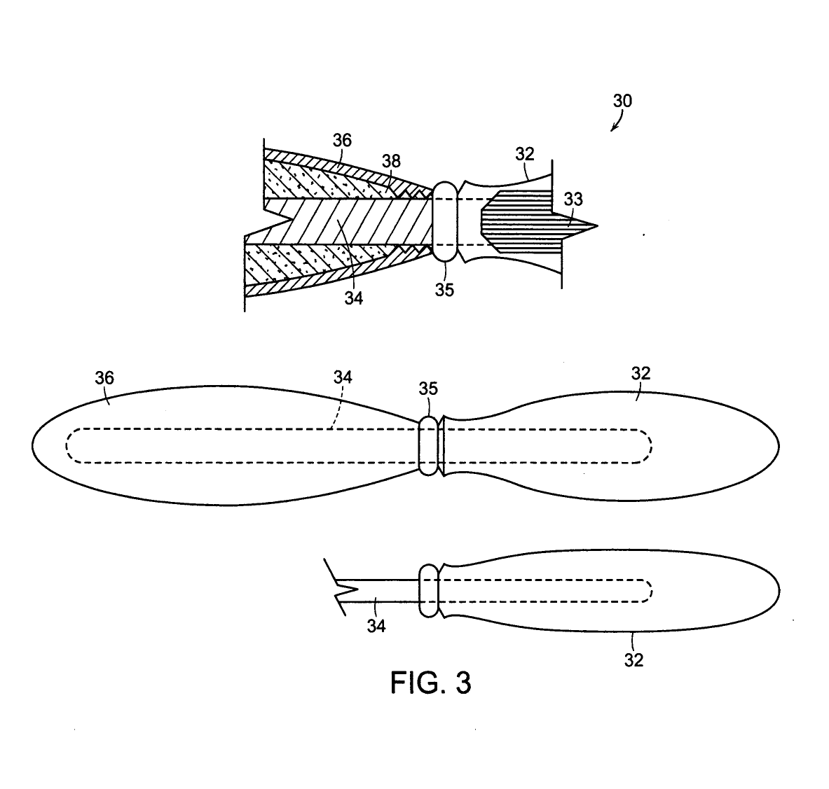

Referring to FIG. 3, an exemplary brush 30 with a shaft 34 and removable head assembly 36 is shown. The exemplary brush 30 includes a handle section 32, a shaft 34, and a removable head assembly 36. An example, the shaft 34 is disposed within the handle 32 and extends outward from the handle 32 for approximately 5½ inches. The shaft 34 can be comprised of a rigid material (e.g. wood, plastic, metal) to provide stiffness to the brush assembly 30. The shaft 34 can have a rectangular, hexagonal, or other cross-section designed to inhibit the head 36 from rotating around the shaft 34. In an embodiment, the brush 30 includes a gasket 35 disposed between the handle 32 and the removable head assembly 36. In operation, the removable head assembly 36 can include grooves or threads 38 which are configured to secure the head 36 onto the shaft 34. Correspondingly, the shaft 34 can include contra grooves or threads to receive and secure the head 36. The gasket 35 can provide friction to help ensure that the head 36 does not rotate about the shaft when the brush 30 is in use. In an embodiment, the handle 32 can include an optional vibration and/or sound producing module 33 configured to create vibrations along the shaft 34 and/or soothing sounds to be emitted through a speaker in the handle section 32 or the shaft 34.

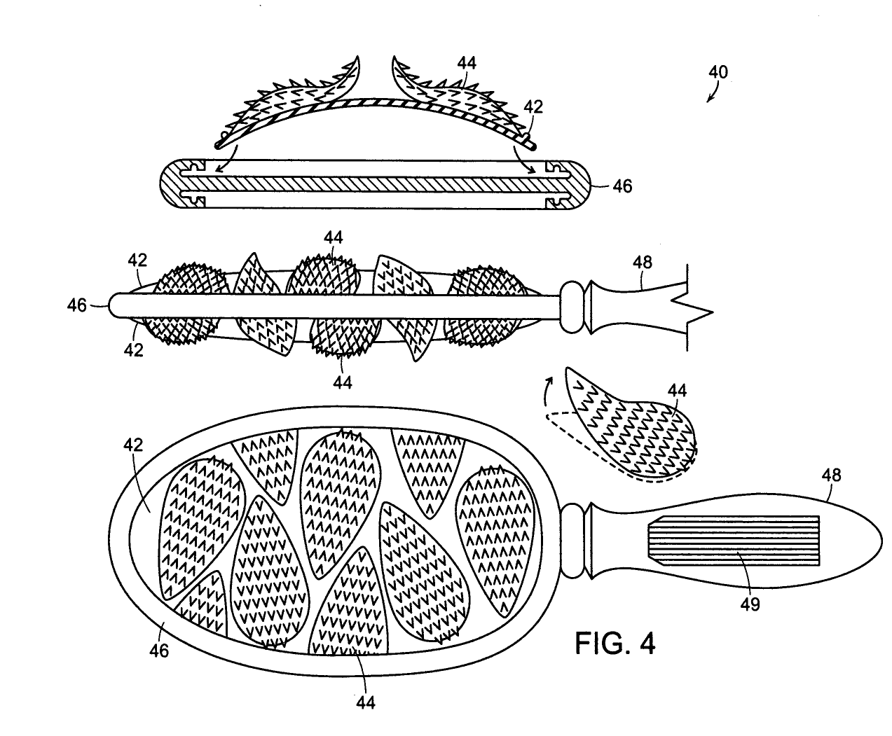

Referring to FIG. 4, with further reference to FIG. 2, multiple views of an exemplary double paddle brush assembly 40 with multiple simulated cat tongues 44 are shown. The simulated cat tongues 44 include rasps 12e as previously described. The double paddle brush assembly 40 includes a handle 48 and a planar backing surface 46. The planar backing surface 46 is generally rigid (e.g. wood, plastic, metal) and is configured to receive the pliant brushing surfaces 42 on one or both sides. The brushing surfaces 42 include a plurality of simulated cat tongues 44 that are partially affixed on one side of the surface 42. In an example, the brushing surfaces 42 mount to the backing surface 46 via a tongue and groove assembly. Other permanent or removable mounting configurations may be used. The removable mount provides the ability to clean or replace the brushing surface 42 as needed. The simulated cat tongues 44 can be affixed to the brushing surface 42 such that only a portion of the tongue 44 is in contact with the brushing surface 42. In an embodiment, the entire tongue 44 is affixed to the brushing surface 42. The tongues 44 can be disposed on the brushing surface 42 to produce a rasping effect in one or more directions. As previously described, the tongues 44 include rasps 12e which are biased in one direction. Each brushing surface 42 can include a collection of tongues 44 which are aligned in one or more directions, with the result of producing a rasping effect by one or more tongues 44 when the brush 40 is moved in one of the corresponding directions. In an embodiment, the tongues 44 can be aligned and affixed to the brushing surfaces 42 such that the rasping effect occurs in a single direction.

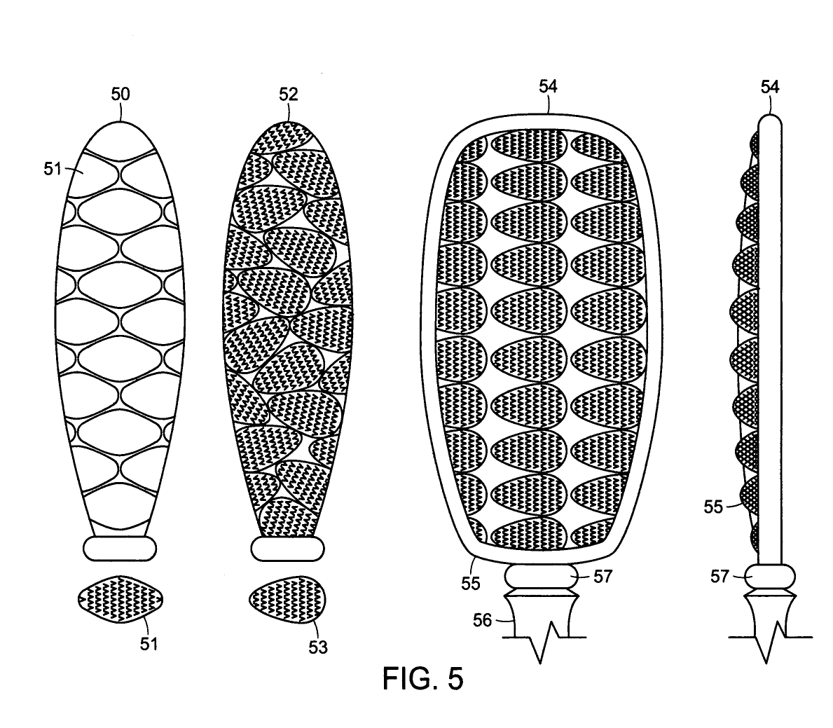

Referring to FIG. 5, with further reference to FIG. 2, exemplary configurations for different round and paddle type brush assemblies are shown. In an embodiment, a removable head assembly 50 can include a plurality of double-ended simulated cat tongues 51 affixed to the outer surface. The double-ended simulated cat tongues 51 include rasps 12e on either end which are biased towards the center of the tongue 51.

The effect is to create a rasping effect with half of the tongue 51 when it is moved in opposing directions. In an embodiment, a removable head assembly 52 can include a plurality of simulated cat tongues 53 that have rasps in a single direction. The tongues 53 can be affixed to the head 52 such that each of the tongues 53 are aligned and the head 52 creates a rasping effect when moved in a single direction. In an example, the tongues 53 are disposed on the head 52 with more than one alignment scheme such that the head 52 creates a rasping effect in more than one direction. In an embodiment, a single paddle head 54 can include a plurality of simulated cat tongues 55 that are generally aligned in a single direction. The paddle head 54 can include a removable handle 56. For example, the handle 56 can include a threaded bolt configured to extend into a threaded opening in the head 54. The head can include a tightening or locking knob 57 to help prevent the head 54 from rotating when in use.

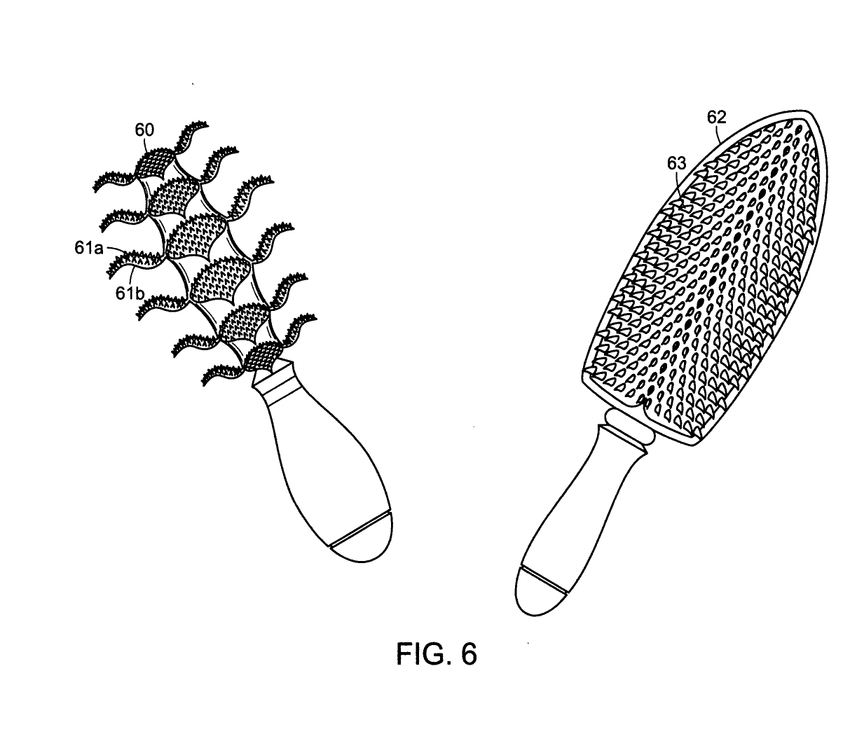

Referring to FIG. 6, with further reference to FIG. 2, exemplary embodiments of brush assemblies are shown. In an embodiment, the simulated cat tongues 61 can be affixed to a removable head 60 in a series of vertical rings, such that the font face 61a of the tongues 61 are facing a distal end of the brush 60. The back side of the tongues 61b faces the handle end of the brush 60. In an embodiment, the back side 61b can be generally pliant, but more rigid than the front face 61a, such that the tongues 61 maintain an outward extending position when in use. In an embodiment, a paddle brush 61 can include a large simulated cat tongue 63. For example, the cat tongue 63 can be cut from a sheet of rasps and affixed to a backing material. In general, the large cat tongue 63 will have a single bias and thus create a rasping effect when the brush 62 is moved in a single direction.

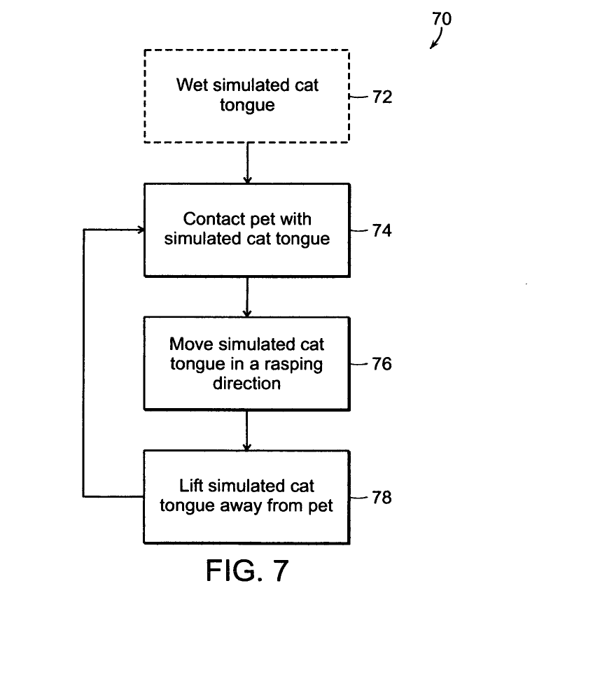

In operation, referring to FIG. 7, with further reference to FIG. 1, a process 70 for grooming a pet using the brush assembly 10 includes the stages shown. The process 70, however, is exemplary only and not limiting. The process 70 may be altered, e.g., by having stages added, removed, or rearranged. The process may also be used with other embodiments of the brush assembly.

The simulated cat tongues 12 on the brush assembly 10 can be used with water, or other liquids, during the grooming process 70. Using a liquid, however, is optional and not required. As an optional step, stage 72 is outlined with a dashed line in FIG. 7. Liquid can be applied to the simulated cat tongues 12 with a spray bottle, or the brush 10 can be dunked in a container. For example, some or all of the head 14 of the brush assembly can be immersed in a liquid. The back side 12b of the tongue can include a porous material (e.g., sponge, cloth, foam) configured to absorb liquid and then release it as the brush 10 is used on the pet. For example, the back side 12b can include a sponge which releases the liquid as the tongue 12 bends when in use.

At stage 72, one or more of the simulated cat tongues 12 on the brush assembly 10 can be placed in contact with the pet to be groomed. The amount of pressure required can vary based on the nature of the pet and their coat. In general, the user is trying to simulate the amount of pressure that would be used if the pet were being groomed by a parent or litter mate. If the brush assembly 10 is configured with an optional vibration module 18, it can be activated via an on/off button to provide more comfort to the pet. An optional sound module may also be activated. In an embodiment, the vibration and/or sound modules can be activated with a pressure switch located in proximity to one or more tongues 12.

At stage 74 the simulated cat tongues 12 can be moved in a direction that is appropriate for the bias of the rasps 12e. For example, the tongues 12 on the brush assembly 10 can includes rasps 12e that are angled inward toward the shaft of the brush. This configuration will create a rasping effect when the tongues 12 are generally moved in a direction that is perpendicular to the axis of the brush head 14. For example, when placed in contact with the pet, the tongues 12 will trail the brush head 14 (i.e., they will be behind the head as compared to the destination of the movement). Since the rasps 12e are pointing toward the head 14, they are pointing in the direction of movement and thus create a rasping effect. The brush assembly 10 may also be rotated as the tongues are in contact with the pet to create a more natural licking motion. For example, the brush assembly 10 can be rotated such that the front side 12a of a row of tongues accelerates towards the destination. Since the brush assembly 10 includes more than one row of tongues, as the brush head 14 rotates additional rows of tongues can come in contact with the pet. As a result, the pet can experience the soothing sensation of multiple simulated tongues 12 on a single stroke of the brush.

At stage 78, the simulated cat tongue 12 can be lifted from the pet when the brush assembly 10 reaches a desired destination (i.e., the brush stroke is completed). In an embodiment, the simulated cat tongues 12 are pliant but contain enough rigidity to return to an outward extending position when no longer in contact with the pet. The rasps 12e can trap loose hair and other debris during the grooming process. Such material can be removed from the tongues 12 by rinsing the tongues in water, rubbing the tongues 12 in a reverse direction (i.e., opposite the bias), or shaking the brush assembly 10 in an outward direction. Other cleaning processes may also be used.

The invention is accordingly defined by the following claims.

What is claimed is:

1. A brush assembly adapted for the grooming the coat of a pet comprising in combination:
A. a casing;
B. a simulated cat tongue affixed to the surface of said casing; and
C. gripping means attached to said casing whereby said simulated cat tongue may be passed over and in contact with said coat.

2. The brush assembly of claim 1 wherein said gripping means comprises a handle.

3. The brush assembly of claim 2 wherein said casing and said handle are separable.

4. The brush assembly of claim 1 wherein said simulated cat tongue comprises a cluster of tines extending outwardly from the surface of said casing.

5. The brush assembly of claim 4 wherein said tines are longitudinally biased toward the surface of said casing.

6. The brush assembly of claim 4 wherein said tines have a longitudinally varying surface texture.

7. The brush assembly of claim 4 wherein said tines are comprised of a pliant material.

8. The brush assembly of claim 4 wherein said tines are comprised of a porous material.

9. The brush assembly of claim 4 wherein said simulated cat tongue is comprised of a plurality of spaced apart clusters of said tines.

10. The brush assembly of claim 4 wherein said handle further includes a sound/vibration module.

11. The brush assembly of claim 10 wherein said sound/vibration module comprises a sound/vibration electrical circuit and a sound/vibration generator driven by said circuit.

12. The brush assembly of claim 4 including a plurality of said clusters mounted on said casing in a pattern of spaced apart positions.

13. The brush assembly of claim 8 wherein said casing further includes a fluid reservoir communicating with said porous tines.

14. The brush assembly of claim 13 wherein said fluid reservoir comprises a sponge.
